(19) United States
(12) Patent Application Publication
(10) Pub. No.: US 2017/0106546 A1
(43) Pub. Date: Apr. 20, 2017

(54) RATCHETING BOLT CUTTER

(71) Applicant: Klein Tools, Inc., Lincolnshire, IL (US)

(72) Inventors: Jose Eduardo Evaro, Lincolnshire, IL (US); Thomas Klein, JR., Lincolnshire, IL (US); Terrance Bolander, Lincolnshire, IL (US); Peter Dohyung Kim, Park Ridge, IL (US)

(21) Appl. No.: 15/295,708

(22) Filed: Oct. 17, 2016

Related U.S. Application Data
(60) Provisional application No. 62/242,432, filed on Oct. 16, 2015.

(51) Int. Cl. B26B 17/02

(52) U.S. Cl. CPC B26B 17/02

(57) ABSTRACT

A bolt cutter includes a first handle, a second handle, a first head connected to the first handle, and a second head connected to the second handle. A pivot mechanism pivotally connects the first head and the second head. A first cutting edge is formed on the first head, and a second cutting edge is formed on the second head in opposing relation to the first cutting edge. A ratcheting mechanism is disposed between the first and second heads. The ratcheting mechanism engages one of the first and second heads to pivotally lock the first head with the second head and permit pivotal motion between the first and second heads only in one direction when the ratcheting mechanism is engaged.

### CROSS REFERENCE TO RELATED APPLICATIONS

This patent application claims the benefit of U.S. Provisional Patent Application Ser. No. 62/242,432, filed on Oct. 16, 2015, which is incorporated herein in its entirety by this reference.

### FIELD OF THE DISCLOSURE

This patent disclosure relates generally to hand tools and, more particularly, to a bolt cutter.

### BACKGROUND

The use of bolt cutters to cut bolts and metal rods is well known. Bolt cutters are designed to provide a very high mechanical advantage at the cutting jaws, typically by employing long handles pivotally connected to the jaws to impart a very high cutting force to a pair of blades, which are located very close to the pivot point. In this way, a relatively large cutting force tending to push the cutting blades together is created, which will typically suffice to yield the metal of the object being cut and, eventually, cut through the object or workpiece.

One drawback of known bolt cutters is their size and, specifically, the overall length of the tool, which because of the long handles that provide the mechanical advantage make the tool difficult to transport and store. Another disadvantage of known bolt cutters is that two hands are usually required to operate the tool. Often, a second person that holds and secures the object to be cut is required. Additionally, known bolt cutters are operated in one motion that delivers the force and work required to cut the work piece. In this way, a large amount of force is required to use the tool despite the large mechanical advantage.

### BRIEF SUMMARY OF THE DISCLOSURE

The present disclosure describes a bolt cutter. The bolt cutter includes a first handle, a second handle, a first head connected to the first handle, and a second head connected to the second handle. A pivot mechanism pivotally connects the first head and the second head such that, when the first and second handle a brought into alignment, the first head pivots towards the second head with a mechanical advantage that increases a force applied to bring the handles together into an increased force tending to push the first and second heads together. A first cutting edge is formed on the first head, and a second cutting edge is formed on the second head in opposing relation to the first cutting edge. A ratcheting mechanism is disposed between the first and second heads. The ratcheting mechanism engages one of the first and second heads to pivotally lock the first head with the second head and permit pivotal motion between the first and second heads only in one direction when the ratcheting mechanism is engaged.

### BRIEF DESCRIPTION OF THE DRAWINGS

FIG. 1 is a left side view of a ratcheting bolt cutter in accordance with the claimed invention;

FIG. 2 is a right side view of the ratcheting bolt cutter shown in FIG. 1;

FIG. 3 is a left side view of the ratcheting bolt cutter shown in FIG. 1 in an open position;

FIG. 4 is a left side view of the ratcheting bolt cutter shown in FIG. 1 in a partially disassembled condition for illustration of internal components;

FIG. 5 is a schematic view of the ratcheting bolt cutter shown in FIG. 1;

FIGS. 6A-C are schematic views of the ratcheting bolt cutter shown in FIG. 1 from various perspectives;

FIGS. 7 and 8 are schematic representations of a bolt cutter in accordance with the disclosure.

FIG. 9 is a front side view of a ratcheting bolt cutter in accordance with the disclosure;

FIG. 10 is a rear side view of the ratcheting bolt cutter shown in FIG. 9;

FIG. 11 is a front side view of an inline power tool head in accordance with the disclosure;

FIG. 12 is a rear top left side view of the inline power tool head shown in FIG. 11; and

FIG. 13 is a front top right side view of an inline power tool incorporating the inline power tool head shown in FIG. 11.

### DETAILED DESCRIPTION

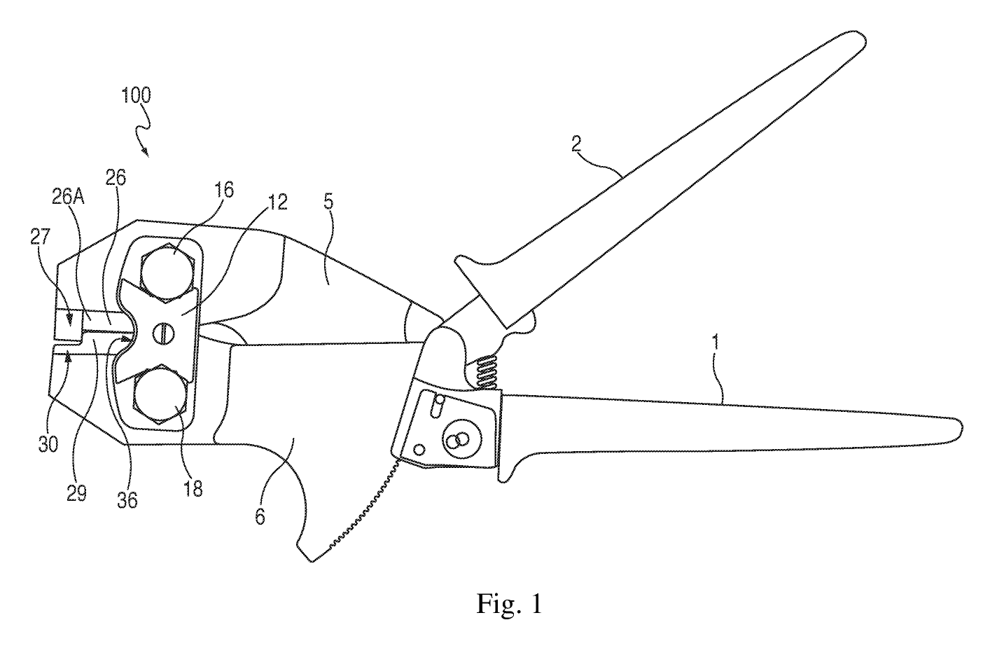

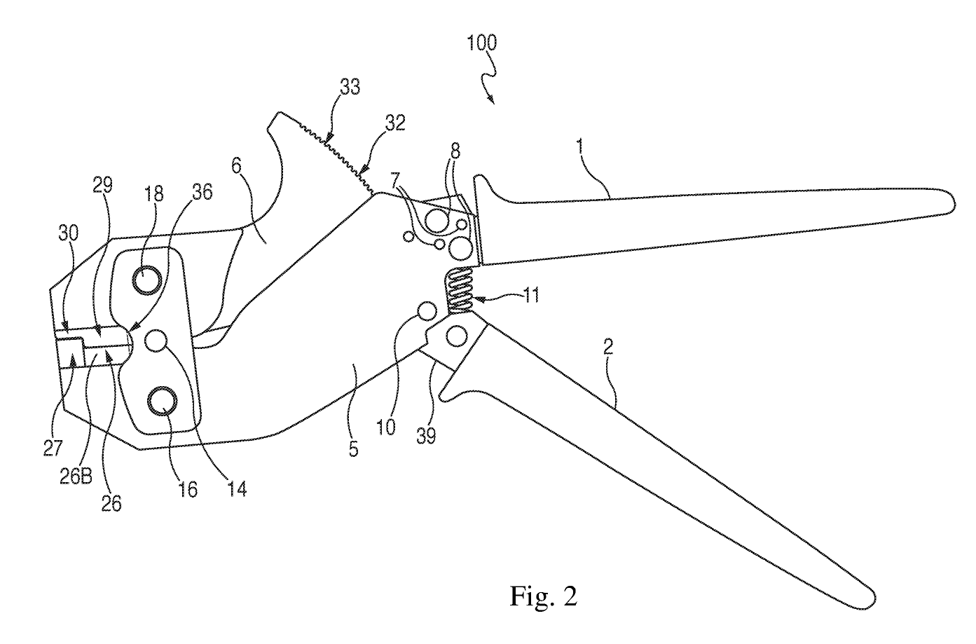

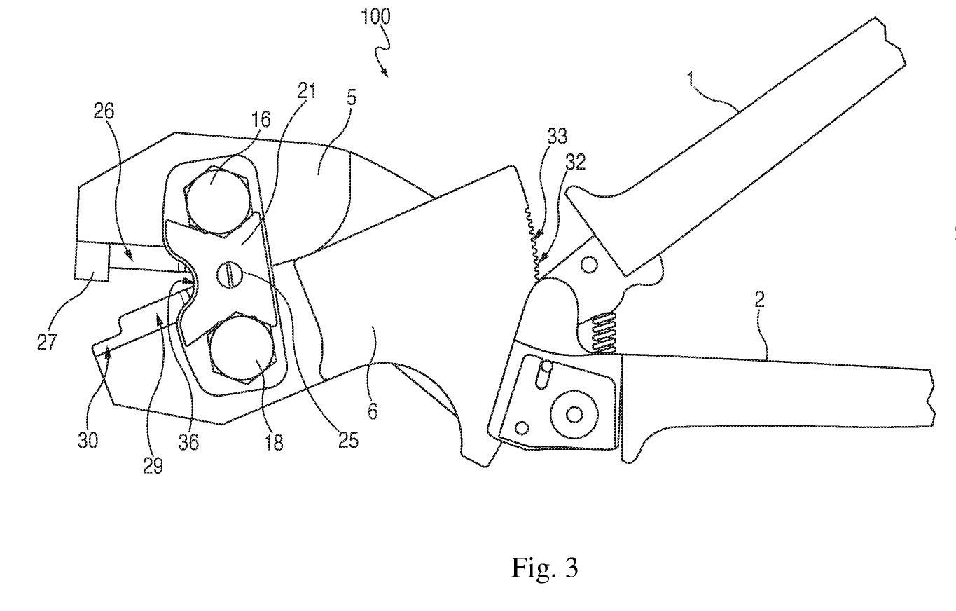

FIG. 1, FIG. 2, and FIG. 3 show one embodiment of a bolt cutter 100. The bolt cutter 100 includes a first handle 1 that is fixedly attached to a fixed head 5. In the illustrated embodiment, as shown in FIG. 2, the fixed connection between the first handle 1 and the fixed head 5 is accomplished by a pair of pins 7 extending through both structures via pin holes 9 in the fixed head 5, and a pair of handle bolts 8, which are fed through two handle bolt holes 3 in the fixed head 5 and threaded into the first handle 1. The fixed head 5 forms a body of the bolt cutter 100 onto which various other components are connected. In reference to FIG. 2, it can be seen that a second handle 2 is pivotally connected to the fixed head 5 via a pin, which is embodied as a rivet 10. The rivet 10 extends through a rivet hole 4 in the fixed head 5 and through the second handle 2. In this way, the second handle 2 swings or pivots with respect to the fixed head 5 and the first handle 1. A connecting element 39 is pivotally connected to the second handle 2 and can be positioned to lock the first and second handles 1 and 2 when the tool is not in use. A return spring 11 is positioned between the first handle 1 and the second 2 to hold the tool in an open position and ready for use.

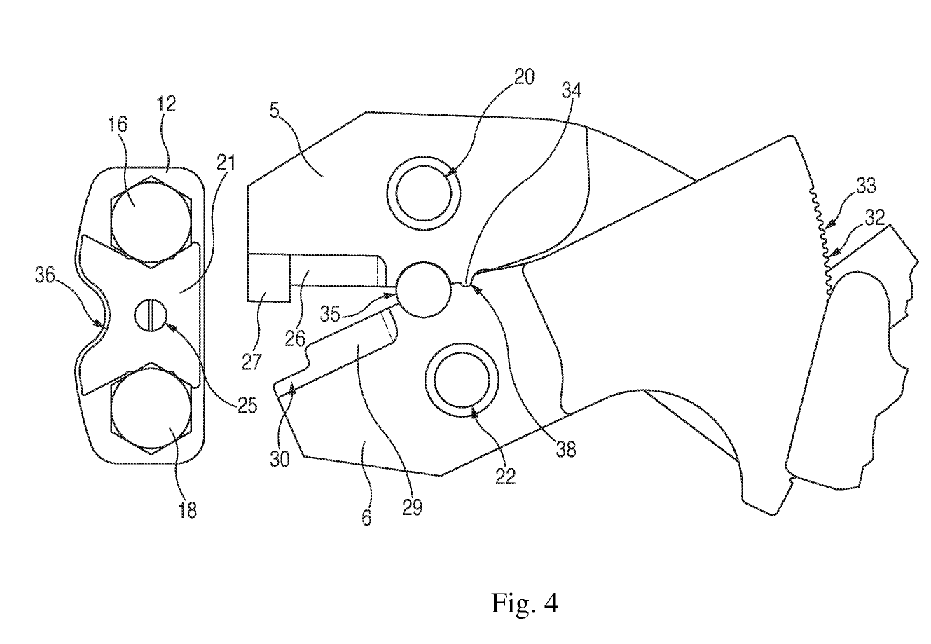

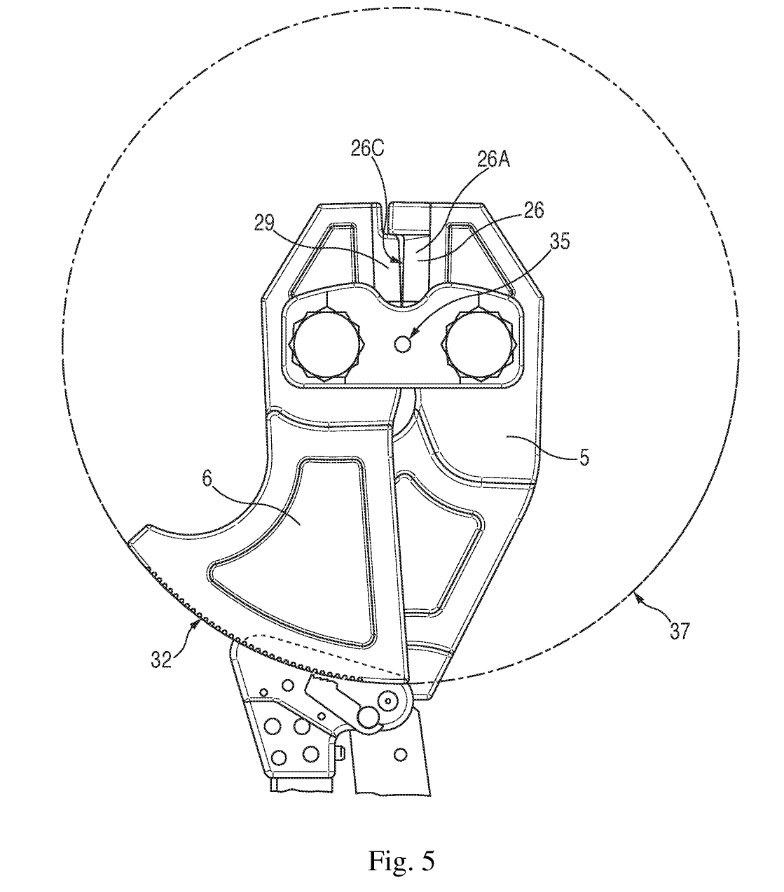

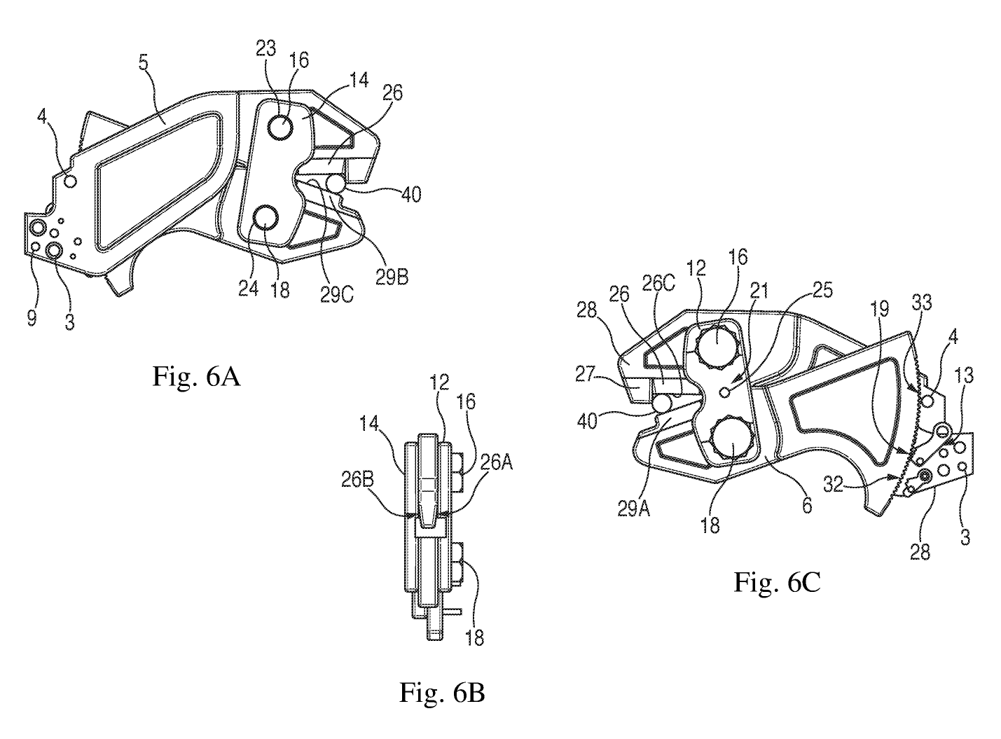

FIG. 4 is a disassembled view of the connecting mechanism between the fixed head 5 and a moving head 6, which together form the cutting portion of the bolt cutter 100. More specifically, the fixed head 5 has a generally plate-shape that forms a cutting element close to an end thereof that is generally opposite the connection to the first and second handles 1 and 2. As shown, the fixed head 5 forms a fixed head blade 26, which is formed by two converging surfaces 26A and 26B (one visible) that meet along a cutting edge 26C (also see FIG. 5) that, during use, engages the workpiece 40 (see FIG. 6A-C). To retain the workpiece in contact with the cutting edge 26C, the fixed head 5 forms a retaining tooth 27 close to an outer end of the cutting edge 26C. During use, the retaining tooth 27 is positioned such that it engages the workpiece, which may be pushed outward by the converging cutting edges of the bolt cutter 100, as shown in FIGS. 6A through 6C. In the illustrated embodiment, a retaining tooth bolster 28 provides support for and prevents breaking of the retaining tooth 27.

The bolt cutter 100 further includes a moving head 6 that is generally pivotally connected to the fixed head 5. In the embodiment shown, as is best illustrated in the disassembled view of FIG. 4, the moving head 6 forms a moving head blade 29, which is formed by two converging surfaces 29A and 29B that meet along a cutting edge 29C. The cutting edge 29C is arranged and configured to align with and mate with the cutting edge 26C when the bolt cutter 100 is in the closed position such that a workpiece disposed between the cutting edges 26C and 29C becomes severed along a cross section disposed and pinched between the cutting edges 26C and 29C. A moving head notch 30 formed close to an outer edge of the cutting edge 29C accommodates the retaining tooth 27 on the moving head 5 when the cutting edges 26C and 29C are mated and the bolt cutter 100 is in a closed position.

The moving head 6 of the tool is attached to the fixed head 5 by an articulated structure that permits more freedom of motion when engaging a workpiece when the bolt cutter 100 is in an open position. In the illustrated embodiment, the articulated structure includes a first side plate 12 and a second side plate 14 disposed on either side of the bolt cutter 100 (see FIGS. 6A-6C). Each of the first and second side plates 12 and 14 forms two openings, that are aligned with each other and also with openings 20 and 22 (see FIG. 4) in the fixed and moving heads 5 and 6. Accordingly, a first side plate bolt 16 is fitted and extends through a first hole 15 formed in the first side plate 12, a first bolt hole 20 formed in the fixed head 5, and threadably engages a first threaded hole 23 in the second side plate 14. Similarly, a second side plate bolt 18 is fitted and extends through a second opening or hole 17 in the first side plate 12, a second bolt hole 22 in the moving head 6, and threadably engages into a second threaded hole 24 in the second side plate 14. The illustrated embodiment further includes a bolt retaining plate 21 that is affixed to the first side plate 12 by a bolt retaining plate screw 25 and is shaped to engage the bolts 16 and 18 to prevent the first side plate bolt 16 and the second side plate bolt 18 from loosening while the tool is in use. Both the first side plate 12 and the second side plate 14 include or form a workpiece notch 36 to allow the workpiece to remain in best with the cutting edges 26C and 29C.

To provide a bearing surface for pivotally moving the fixed and moving heads 5 and 6, a floating pin 35 is captured between the first side plate 12 and the second side plate 14 and is disposed between the fixed head 5 and the moving head 6 of the tool, as can be seen in FIG. 4. To prevent sliding between the fixed and moving heads 5 and 6 when the tool is in the open position, tongue 34 and groove 36 features are formed in the heads 5 and 6 just behind the floating pin 35, opposite the cutting edges 26C and 29C.

For applying a force tending to push the cutting edges 26C and 29C together during use, the moving head forms a ratchet wheel 32 on a side opposite the cutting edge 29C relative to the floating pin 35. In the illustrated embodiment, the ratchet wheel 32 is formed as a segment of a circular arc and forms a plurality of ratchet teeth 33 arranged in equal spacings along its outer circular segmented periphery. As shown in FIG. 6C, a driving pawl 13 having a plurality of driving teeth 19 meshes or otherwise engages the ratchet wheel 32 and provides the primary motivating structure during use to push the cutting edges 26C and 29C together by driving the moving head 6 against the fixed head 5. To release the tool, or when advancing the ratcheting action of the tool while maintaining a cutting force on the workpiece, the driving pawl may be 13 may be disengaged while a retaining pawl 28, which also forms one or more retaining pawl teeth 31, meshably engages the ratchet wheel 32 to maintain the position of the moving blade 5 relative to the fixed blade 6.

During use, when the second handle 2 is pushed against the first handle 1, the driving pawl 13 engages and pushes the ratchet wheel 32 in the direction of motion of the second handle 2. The first side plate 12, second side plate 14, first side plate bolt 16, and second side plate bolt 18, prevent the fixed head 5 and moving head 6 from separating and cause them instead to rotate around the floating pin 35 in a direction that brings the cutting edges 26C and 29C closer together. The combination and cooperation of these structures forces the moving head 6 to pivot about the floating pin 35 and drives the fixed head blade 26 and the moving head blade 29 into the workpiece. When the second handle 2 is retracted, retaining pawl 28 engages the ratchet wheel 32 allowing the driving pawl 13 to disengages from the ratchet wheel 32 and move with the second handle 2 to its original position.

FIG. 5 shows the relative positions of the various structures of the bolt cutter 100. As can be seen from this schematic illustration, the floating pin 35 is disposed at or close to a geometric center of the ratchet wheel 32 such that a force applied tangentially on the circle by the meshing or engagement of the ratchet wheel 32 and the driving pawl 13 causes a corresponding force onto the workpiece but with a mechanical advantage with the floating pin 35 acting as the fulcrum. To maximize the leverage of the tool, the ratchet wheel 32 and driving pawl 13 are located at the periphery of a circle and are both of the same diameters. The fixed head blade 26 and the moving head blade 29 are radially located close to the floating pin 35 to maximize leverage. In the embodiment illustrated, the fixed head 5 of the tool is swept back from the first handle 1, allowing the floating pin 35 to be centrally located to maximize the mechanical advantages imparted to the moving head blade 29 against the fixed head blade 26.

Each repeated advancement of the second handle 2 advances the moving head blade 29 closer to the fixed head blade 26, and thus further into the workpiece, until the force applied to the workpiece by the cutting edges 26C and 29C causes the material of the workpiece to yield, plastically deform and, ultimately, fracture. The fracture in some materials results from the pressure applied at a cutting cross section of the workpiece and also by a force tending to pull the two parts of the workpiece apart by virtue of the converging surfaces 26A and B, and 29A and B, of the bolt cutter 100. In the illustrated embodiment, the surfaces 26A and 26B diverge from the cutting edge 26C at an angle of 55° to effectively displace material and pull apart the two portions of the workpiece disposed on either side of the cross section being cut. Similarly, the two surfaces 29A and 29B diverge from the cutting edge 29C by an angle of 55°, but in both cutting edges other angles may be used based on the type of material that will be cut. The angle of 55° was selected as being suitable for a broad range of expected materials that may be cut by the bolt cutter 100. In order to withstand the forces imparted to them, the moving head 6 an the fixed head 5 are through hardened to 52-55 HRC and the fixed head blade 26 and the moving head blade 29 are induction hardened to 55-60 HRC. Advantageously, by using the mechanical advantage provided by the ratcheting mechanism, and also by utilizing the application of the cutting force in discrete increments, the length of the bolt cutter 100, for example, the handles 1 and 2, can be considerably shortened relative to known bolt cutter designs. In the illustrated embodiment, each handle is about 1.5 times in length relative to the cutting head.

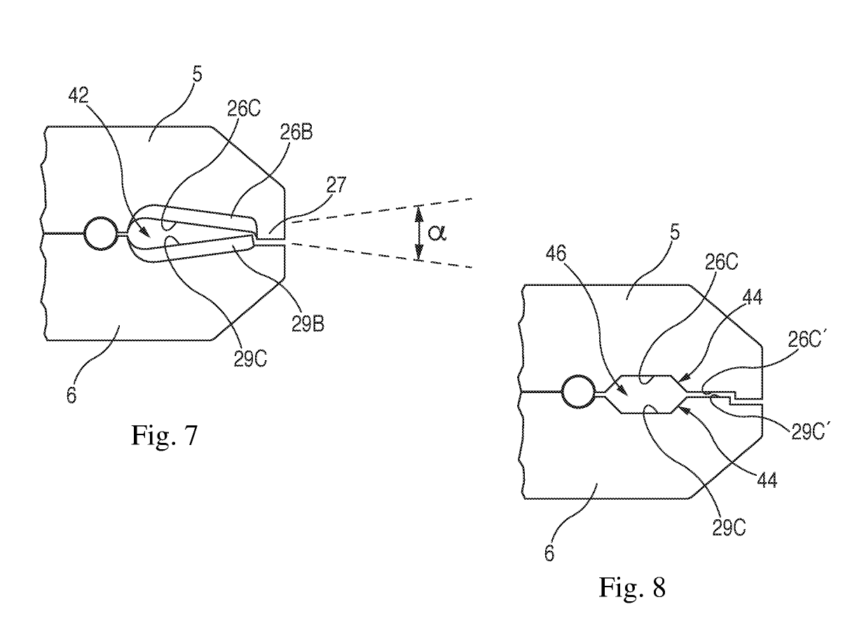

Two alternative embodiments for the configuration of the cutting edges 26C and 29C are shown in FIGS. 7 and 8. It should be appreciated that these alternative embodiments are exemplary and other configurations may also be used.

In FIG. 7, the cutting edges 26C and 29C are disposed at an angle relative to one another when the bolt cutter 100 is in the closed position, thus creating a wedge-shaped opening 42 that accommodates a central portion of the object to be cut. In this embodiment, the cutting edges are disposed at an angle, α, of about 26 degrees, but other angles can be used. The wedge-shaped opening 42 may be arranged to urge the workpiece towards the center of the bolt cutter, depending on the size of the workpiece, to secure the same between the cutting edges and avoid its possible slippage. Thus the retaining tooth 27 in this embodiment may be optional.

In the embodiment shown in FIG. 8, the cutting edges 26C and 29C are stepped in two sections, while more than two sections may be used. Specifically, the cutting edge 26C forms a step 44 and a second, outer section 26C′. Similarly, the cutting edge 29C forms a step 44 that separates the inner portion thereof from an outer section 29C′. While the outer sections 26C′ and 29C′ are matingly arranged, the cutting edges 26C and 29C form an opening 46 therebetween that accommodates a central portion of the object to be cut. In this embodiment, the opening 46 may be arranged to retain the workpiece towards the center of the bolt cutter, depending on the size of the workpiece, to secure the same between the cutting edges and avoid its possible slippage. Thus the retaining tooth 27 in this embodiment as well may be optional.

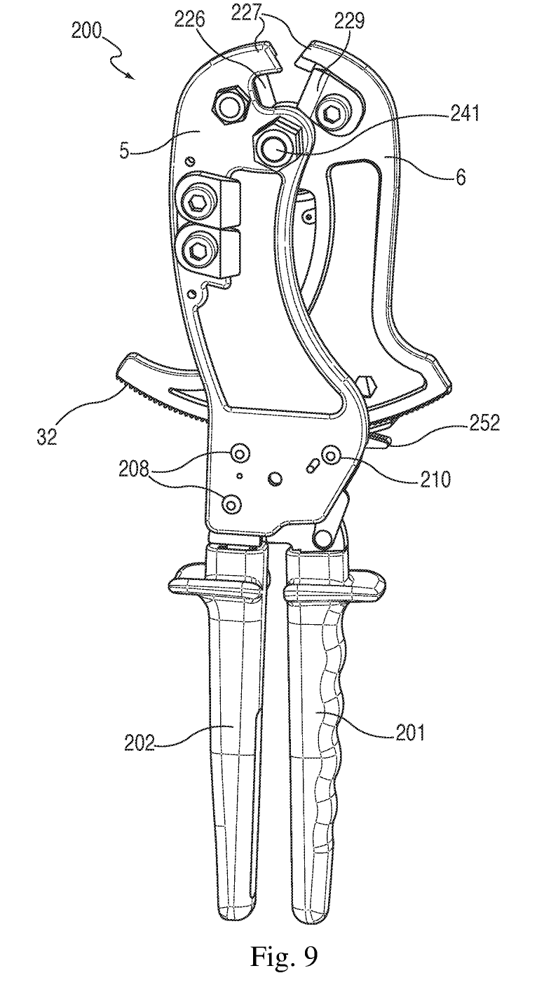

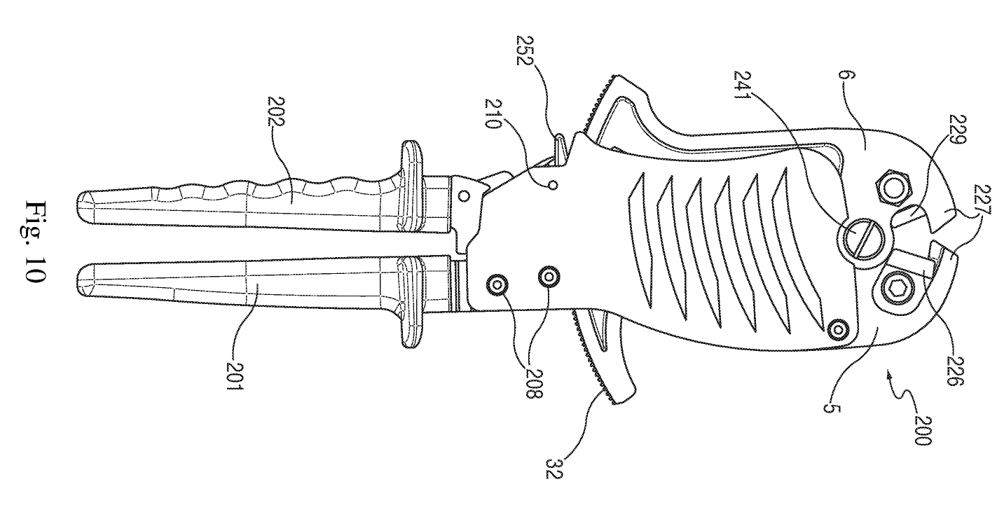

FIG. 9 and FIG. 10 depict an alternate embodiment for a ratcheting bolt cutter 200 in accordance with the disclosure. In the description that follows, structures and features that are the same or similar to corresponding structures and features previously described are denoted by the same reference numerals as previously used for simplicity. Accordingly, the bolt cutter 200 includes a fixed first handle 201, movable second handle 202, fixed head 5, and moving head 6. In the illustrated embodiment, the fixed handle 201 is secured to the fixed head 5 using handle bolts 208, but any other permanent or releasable mounting arrangement may be used. The movable handle 202 is pivotally engaged to the fixed head 5 via a rivet 210. In this arrangement, when the when the second handle 202 is pushed against the first handle 201, a driving pawl (not shown) engages and pushes a ratchet wheel 32 in the direction of motion of the second handle 202. This in turn forces, drives or urges the moving head to rotate about a pivot bolt 241, driving a removable and replaceable fixed head blade 26 against a removable and replaceable moving head blade 29. When the second handle 202 is retracted, retaining pawl (not shown) that is activated by a lever 252 engages the ratchet wheel 32 allowing the driving pawl to disengage the ratchet wheel 32 and move with the second handle 202 to its original, open position.

Unlike the device of FIG. 1, the bolt cutter 200 includes two retaining teeth 227, which are formed as the same component, meaning, they are interchangeable. One of the retaining teeth 227 is connected on the moving head 5, and the second is formed on the fixed head 6. In the illustrated embodiment, the retaining teeth 227 are integrally formed on the ends of their respective heads, but it should be appreciated that they may alternatively be formed as removeable or replaceable pieces. The two retaining teeth 227 have complementing shapes when installed such that they interlock when the cutter is in the closed or cutting position. The function of the ratcheting bolt cutter 200 is otherwise identical to the bolt cutter shown, for example, in FIG. 1, in that the user of the bolt cutter applies a force to the moving handle 202 to push the moving head blade 229 and the fixed head blade 226 together while gaining significant mechanical advantage as a result of leverage about the pivot bolt 241. In the embodiment of FIG. 1, the user may augment the mechanical advantage provided to the force pressing to close the handles through the swept back design.

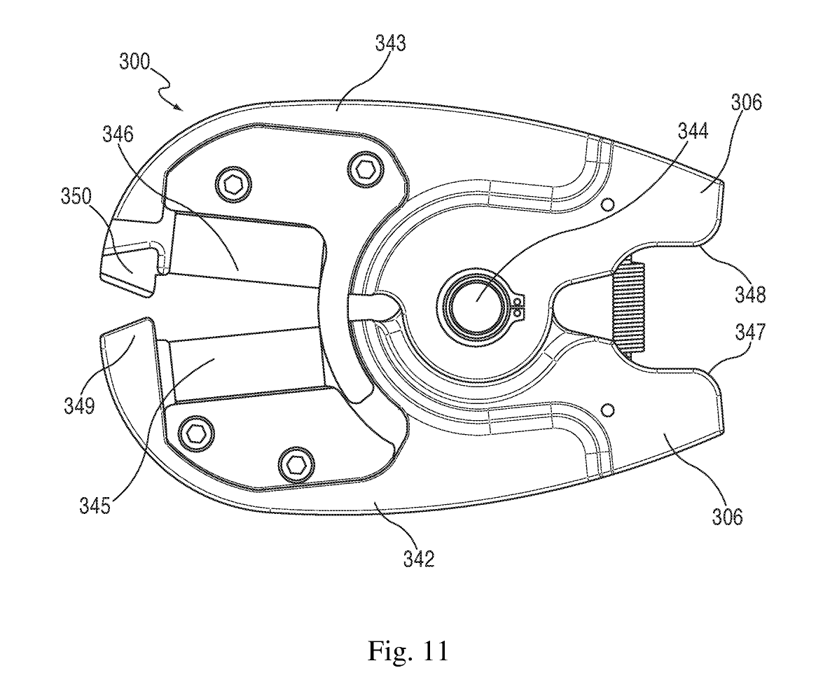

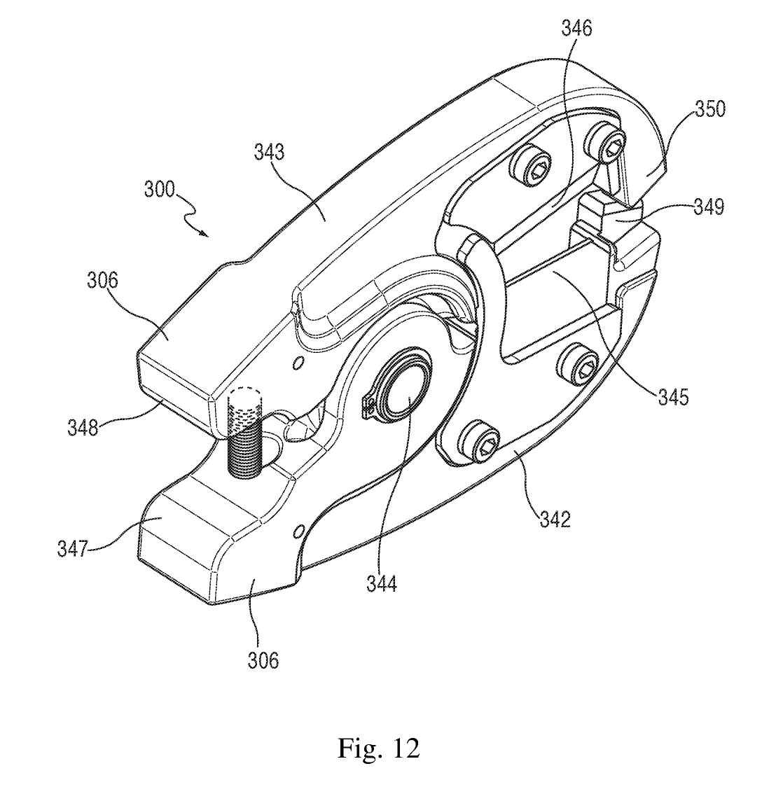

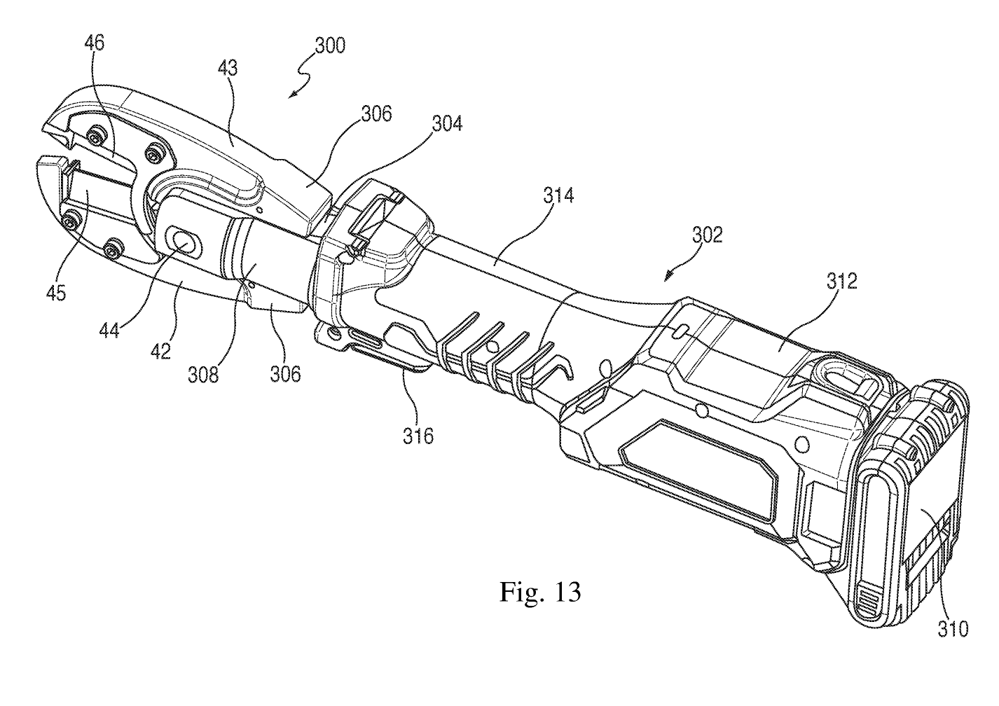

FIG. 11 and FIG. 12 depict an inline power tool head 300 incorporating the inventive design, featuring a first cutter head 342 and a second cutter head 343 connected to one another via a pivot bolt 344. The first cutter head 342 carries a removable and replaceable first cutting blade 345 and the second cutter head 343 carries a removable and replaceable second cutting blade 346. The first cutter head 342 also features a first inline engagement surface 347 and the second cutter head features a second inline engagement surface 348 that are formed in opposing relation within projections 306. Actuators 304 of an inline power tool 302, shown in FIG. 13, engage and push apart the projections 306 to close the cutter heads 342 and 343 during a cutting operation. When the actuators 304 are active, the first and second inline engagement surfaces 347 and 348 are driven apart, forcing the first cutter head 342 and second cutter head 343 to rotate about the pivot bolt 344 and forcing the first cutting blade 345 and second cutting blade 346 together with high force. The inline power tool 302 further engages the cutter along the pivot bolt 344 with a U shaped yoke 308 that extends along both sides of the cutting tool head 300. A first retaining tooth 349 on the first cutter head 342 and a second retaining tooth 350 on the second cutter head 343 restrain the workpiece (not shown) and prevent it from being ejected from between the first cutting blade 345 and the second cutting blade 346.

FIG. 13 depicts the inline power tool head 300 shown in FIG. 11 mounted on a typical inline power tool 302. The inline power tool 302 includes a battery or power source 310 that powers a motor with reducing gears (not shown) mounted and operating within a housing 312. The housing is connected to a handle 314 that includes a trigger 316. During use, a user holds the handle 314 and activates the trigger 316 to complete an electrical connection that provides power to a motor within the housing 312. As the motor operates, a force tending to push the actuators 304 apart forces the tool head 300 to close and thus cut an article the user placed between the cutter heads 342 and 343.

Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context.

The use of the terms “a” and “an” and “the” and “at least one” and similar referents in the context of describing the invention (especially in the context of the following claims) are to be construed to cover both the singular and the plural, unless otherwise indicated herein or clearly contradicted by context. The use of the term “at least one” followed by a list of one or more items (for example, “at least one of A and B”) is to be construed to mean one item selected from the listed items (A or B) or any combination of two or more of the listed items (A and B), unless otherwise indicated herein or clearly contradicted by context.

Accordingly, this disclosure includes all modifications and equivalents of the subject matter recited in the claims appended hereto as permitted by applicable law. Moreover, any combination of the above-described elements in all possible variations thereof is encompassed by the disclosure unless otherwise indicated herein or otherwise clearly contradicted by context.

It will be appreciated that the foregoing description provides examples of the disclosed system and technique. However, it is contemplated that other implementations of the disclosure may differ in detail from the foregoing examples. All references to the disclosure or examples thereof are intended to reference the particular example being discussed at that point and are not intended to imply any limitation as to the scope of the disclosure more generally. All language of distinction and disparagement with respect to certain features is intended to indicate a lack of preference for those features, but not to exclude such from the scope of the disclosure entirely unless otherwise indicated.

We claim:

1. A bolt cutter, comprising:
a first handle;
a second handle;
a first head connected to the first handle;
a second head connected to the second handle;
a pivot mechanism that pivotally connects the first head and the second head such that, when the first and second handle a brought into alignment, the first head pivots towards the second head with a mechanical advantage that increases a force applied to bring the handles together into an increased force tending to push the first and second heads together;
a first cutting edge formed on the first head;
a second cutting edge formed on the second head in opposing relation to the first cutting edge; and
a ratcheting mechanism disposed between the first and second heads, the ratcheting mechanism engaging one of the first and second heads to pivotally lock the first head with the second head and permit pivotal motion between the first and second heads only in one direction when the ratcheting mechanism is engaged.

2. The bolt cutter of claim 1, further comprising a first tooth connected to the first head and disposed adjacent an edge of the first cutting edge, the first tooth creating a barrier for a workpiece disposed between the first and second cutting edges during a cutting operation.

3. The bolt cutter of claim 2, further comprising a second tooth connected to the second tooth and disposed adjacent an edge of the second cutting edge, the second tooth matingly cooperating with the first tooth to augment the barrier for the workpiece during the cutting operation.

4. The bolt cutter of claim 1, wherein the pivot mechanism is a bolt extending through the first and second heads.

5. The bolt cutter of claim 1, wherein the pivot mechanism is a bolt retaining plate that is pivotally connected to each of the first and second heads.

6. The bolt cutter of claim 1, wherein the first and second edges, when in the closed position, are at least one of parallel and non-parallel.

7. The bolt cutter of claim 1, wherein the ratcheting mechanism includes:
a ratcheting wheel connected to the first head;
a plurality of teeth formed on the ratcheting wheel;
a retaining pawl pivotally connected to the second head;
wherein the retaining pawl meshes with the ratcheting wheel to prevent motion of the first head relative to the second head in one direction.

8. The bolt cutter of claim 7, further comprising a lever connected to the retaining pawl and operable to release a meshing engagement of the ratcheting pawl with the ratcheting wheel.

9. The bolt cutter of claim 8, further comprising a return spring urging the first and second heads in an opening direction.

10. The bolt cutter of claim 1, wherein each of the first and second handles is formed as a projection forming a respective inline engagement surface, the respective inline engagement surfaces being in opposed relation.

11. The bolt cutter of claim 10, further comprising an inline actuator engaged with the first and second heads and having actuators bearing on the respective inline engagement surfaces such that, when the inline actuator is active, the respective inline engagement surfaces are pushed apart.
